(19) United States
(12) Patent Application Publication
(10) Pub. No.: US 2016/0191550 A1
(43) Pub. Date: Jun. 30, 2016

(54) MICROVISOR-BASED MALWARE DETECTION ENDPOINT ARCHITECTURE

(71) Applicant: FireEye, Inc., Milpitas, CA (US)

(72) Inventors: Osman Abdoul Ismael, Palo Alto, CA (US); Ashar Aziz, Coral Gables, FL (US)

(21) Appl. No.: 14/929,821

(22) Filed: Nov. 2, 2015

Related U.S. Application Data
(60) Provisional application No. 62/097,485, filed on Dec. 29, 2014.

(51) Int. Cl. H04L 29/06; G06F 21/56

(52) U.S. Cl. CPC H04L 63/1416; H04L 63/1433; H04L 63/0428; H04L 63/20; H04L 63/10; H04L 63/1425; G06F 21/566

(57) ABSTRACT

A threat-aware microvisor may be deployed in a malware detection endpoint architecture and execute on an endpoint to provide exploit and malware detection within a network environment. Exploit and malware detection on the endpoint may be performed in accordance with one or more processes embodied as software modules or engines configured to detect suspicious and/or malicious behaviors of an operating system process (object), and to correlate and classify the detected behaviors as indicative of malware. Detection of suspicious and/or malicious behaviors may be performed by static and dynamic analysis of the object. Static analysis may perform examination of the object to determine whether it is suspicious, while dynamic analysis may instrument the behavior of the object as the operating system process runs via capability violations of, e.g. operating system events. A behavioral analysis logic engine and a classifier may thereafter cooperate to perform correlation and classification of the detected behaviors.

### RELATED APPLICATION

The present application claims priority from commonly owned Provisional Patent Application No. 62/097,485, entitled Microvisor-Based Malware Detection Endpoint Architecture, filed on Dec. 29, 2014, the contents of which are incorporated herein by reference.

### BACKGROUND

1. Technical Field The present disclosure relates to malware detection and, more specifically, to a microvisor-based malware detection architecture.

2. Background Information

A virtual machine monitor (VMM) or hypervisor may be a hardware or software entity configured to create and run a software implementation of a computing platform or machine, i.e., a virtual machine. The hypervisor may be implemented as a type 1 VMM executing directly on native hardware of the computing platform, or a type 2 VMM executing within an operating system environment of the platform. The hypervisor may be further deployed in a virtualization system that fully simulates (virtualizes) physical (hardware) resources of the computing platform. Such a full virtualization system may support execution of a plurality of operating system instances inside a plurality of virtual machines, wherein the operating system instances share the hardware resources of the platform. The hypervisor of the full virtualization system may manage such sharing by hiding the hardware resources of the computing platform from users (e.g., application programs) executing on each operating system instance and, instead, providing an abstract, virtual computing platform.

A prior implementation of a virtualization system includes a special virtual machine and a hypervisor that creates other virtual machines, each of which executes an independent instance of an operating system. Malicious code may be prevented from compromising resources of the system through the use of policy enforcement and containment analysis that isolates execution of the code within a virtual machine to block or inhibit its execution within the system (i.e., outside of the virtual machine). However, this implementation duplicates program code and data structures for each instance of the operating system that is virtualized. In addition, the policy enforcement and containment may be directed to active (often computationally intensive) analysis of operating system data streams (typically operating system version and patch specific) to detect anomalous behavior.

Accordingly, there is a need for an enhanced virtualization system that detects anomalous behavior of malware (e.g., exploits and other malicious code threats) and collects analytical information relating to such behavior.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a network environment that may be advantageously used with one or more embodiments described herein;

FIG. 2 is a block diagram of a node that may be advantageously used with one or more embodiments described herein;

FIG. 3 is a block diagram of the threat-aware microvisor that may be advantageously used with one or more embodiments described herein;

FIG. 4 is a block diagram of a malware detection endpoint architecture that may be advantageously used with one or more embodiments described herein;

FIG. 5 is an example procedure for deploying the threat-aware microvisor in a malware detection endpoint architecture; and

FIG. 6 is a block diagram of an exemplary micro-virtualization architecture including a trusted computing base that may be configured to provide a trusted malware detection environment in accordance with one or more embodiments described herein.

### OVERVIEW

The embodiments described herein provide a threat-aware microvisor deployed in a malware detection endpoint architecture and executing on an endpoint to provide exploit and malware detection within a network environment. Exploit and malware detection on the endpoint may be performed in accordance with one or more processes embodied as software modules or engines configured to detect suspicious and/or malicious behaviors of an operating system process when, e.g., executing an object, and to correlate and classify the detected behaviors as indicative of malware. Detection of suspicious and/or malicious behaviors may be performed by static and dynamic analysis of the operating system process and/or its object. Static analysis may perform examination of the object to determine whether it is suspicious, while dynamic analysis may instrument the behavior of the object as the operating system process runs via capability violations of, e.g. operating system events. A behavioral analysis logic engine (BALE) and a classifier may thereafter cooperate to perform correlation and classification of the detected behaviors.

In an embodiment, the static analysis may examine the object to determine whether it is suspicious and/or malicious. To that end, the static analysis may include a static inspection engine and a heuristics engine executing as user mode processes of the operating system kernel. The static inspection engine and heuristics engine may employ statistical analysis techniques, including the use of vulnerability/exploit signatures and heuristics, to perform non-behavioral analysis in order to detect anomalous characteristics (i.e., suspiciousness and/or malware) without processing (instrumenting) of the object. The statistical analysis techniques may produce static analysis results that include, e.g., identification of communication protocol anomalies and/or suspect source addresses of known malicious servers.

The dynamic analysis may include exploit detection using, e.g., the threat-aware microvisor (“microvisor”) and a micro-virtual machine (VM) to observe behaviors of the object. The behaviors of the object may be observed by instrumenting the object (using, e.g., instrumentation logic) as the operating system process runs at micro-VM, wherein the observed run-time behaviors may be captured as dynamic analysis results. Illustratively, monitors may be employed during the dynamic analysis to monitor the run-time behaviors of the object and capture any resulting activity. The monitors may be embodied as capability violations configured to trace particular operating system events. During instrumenting of the object at the micro-VM, the system events may trigger capability violations (e.g., exceptions or traps) generated by the microvisor to enable monitoring of the object's behaviors during run-time.

The static analysis results and dynamic analysis results may be provided as inputs to the BALE, which may provide correlation information to the classifier. The BALE may be embodied as a rules-based correlation engine illustratively executing as an isolated process disposed over the microvisor. The BALE may be configured to operate on rules that define, among other things, sequences of known malicious events that may collectively correlate to malicious behavior. The rules of the BALE may be correlated against the dynamic analysis results, as well as static analysis results, to generate correlation information pertaining to, e.g., a level of risk or a numerical score used to arrive at a decision of maliciousness. The classifier may be embodied as a classification engine executing as a user mode process of the operating system kernel and configured to use the correlation information provided by BALE to render a decision as to whether the object is malicious. Illustratively, the classifier may be configured to classify the correlation information, including monitored behaviors (expected and unexpected/anomalous) and capability violations, of the object relative to those of known malware and benign content.

In an embodiment, the microvisor may be stored in memory of the endpoint as a module of a trusted computing base (TCB) that also includes a root task module configured to cooperate with the microvisor to load one or more other modules executing on the endpoint. In addition, one or more of the malware detection system engines (modules) may be included in the TCB to provide a trusted malware detection environment. Illustratively, it may be desirable to organize modules associated with a decision of malware to be part of the TCB. For example, the BALE and/or classifier may be included in the TCB for the endpoint.

### DESCRIPTION

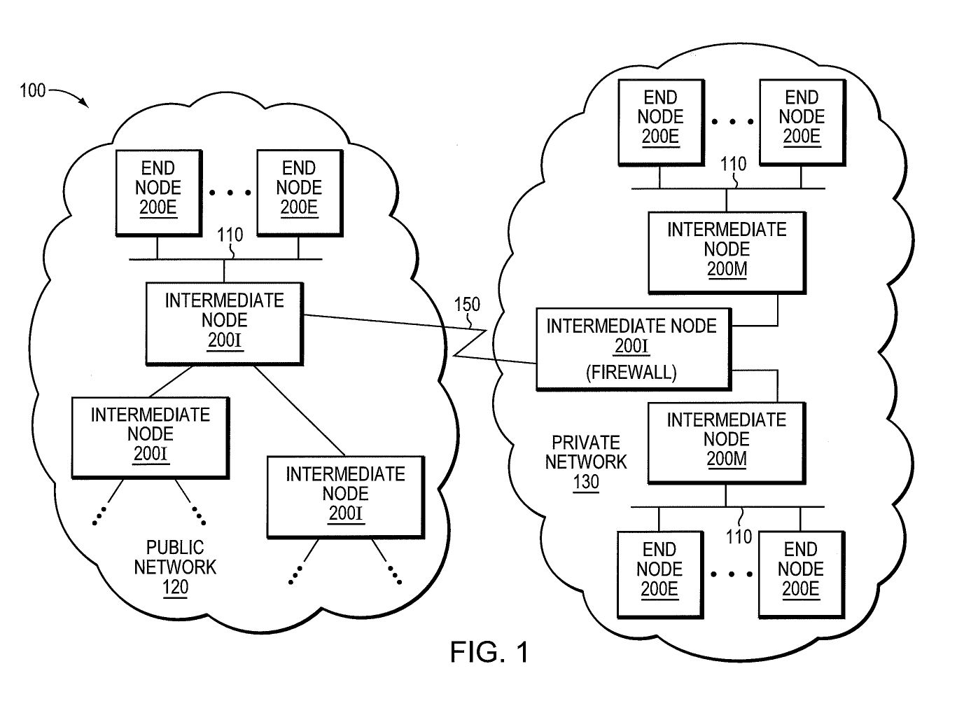

FIG. 1 is a block diagram of a network environment 100 that may be advantageously used with one or more embodiments described herein. The network environment 100 illustratively includes a plurality of computer networks organized as a public network 120, such as the Internet, and a private network 130, such an organization or enterprise (e.g., customer) network. The networks 120, 130 illustratively include a plurality of network links and segments connected to a plurality of nodes 200. The network links and segments may include local area networks (LANs) 110 and wide area networks (WANs) 150, including wireless networks, interconnected by intermediate nodes 200_{I} to form an internetwork of nodes, wherein the intermediate nodes 200_{I} may include network switches, routers and/or one or more malware detection system (MDS) appliances (intermediate node 200_{M}). As used herein, an appliance may be embodied as any type of general-purpose or special-purpose computer, including a dedicated computing device, adapted to implement a variety of software architectures relating to exploit and malware detection functionality. The term “appliance” should therefore be taken broadly to include such arrangements, in addition to any systems or subsystems configured to perform a management function for exploit and malware detection, and associated with other equipment or systems, such as a network computing device interconnecting the WANs and LANs. The LANs 110 may, in turn, interconnect end nodes 200_{E} which, in the case of private network 130, may be illustratively embodied as endpoints.

In an embodiment, the endpoints may illustratively include, e.g., client/server desktop computers, laptop/notebook computers, process controllers, medical devices, data acquisition devices, mobile devices, such as smartphones and tablet computers, and/or any other intelligent, general-purpose or special-purpose electronic device having network connectivity and, particularly for some embodiments, that may be configured to implement a virtualization system. The nodes 200 illustratively communicate by exchanging packets or messages (i.e., network traffic) according to a predefined set of protocols, such as the Transmission Control Protocol/Internet Protocol (TCP/IP); however, it should be noted that other protocols, such as the HyperText Transfer Protocol Secure (HTTPS), may be advantageously used with the embodiments herein. In the case of private network 130, the intermediate node 200_{I} may include a firewall or other network device configured to limit or block certain network traffic in an attempt to protect the endpoints from unauthorized users. Unfortunately, such conventional attempts often fail to protect the endpoints, which may be compromised.

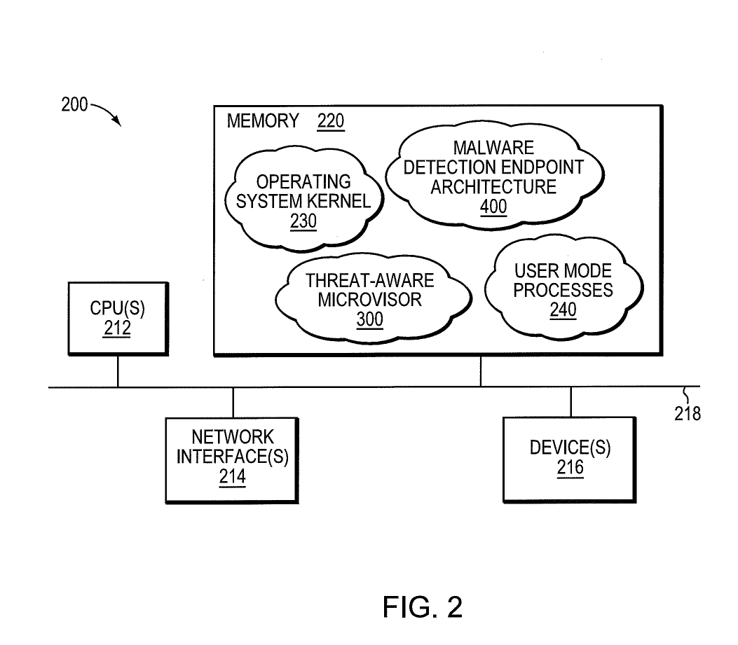

FIG. 2 is a block diagram of a node 200, e.g., end node 200_{E}, that may be advantageously used with one or more embodiments described herein. The node 200 illustratively includes one or more central processing unit (CPUs) 212, a memory 220, one or more network interfaces 214 and one or more devices 216 connected by a system interconnect 218, such as a bus. The devices 216 may include various input/output (I/O) or peripheral devices, such as storage devices, e.g., disks. The disks may be solid state drives (SSDs) embodied as flash storage devices or other non-volatile, solid-state electronic devices (e.g., drives based on storage class memory components), although, in an embodiment, the disks may also be hard disk drives (HDDs). Each network interface 214 may include one or more network ports containing the mechanical, electrical and/or signaling circuitry needed to connect the node to the network 130 to thereby facilitate communication over the network. To that end, the network interface 214 may be configured to transmit and/or receive messages using a variety of communication protocols including, inter alia, TCP/IP and HTTPS.

The memory 220 may include a plurality of locations that are addressable by the CPU(s) 212 and the network interface(s) 214 for storing software program code (including application programs) and data structures associated with the embodiments described herein. The CPU 212 may include processing elements or logic adapted to execute the software program code, such as threat-aware microvisor 300 and modules of malware detection endpoint architecture 400, and manipulate the data structures. Exemplary CPUs may include families of instruction set architectures based on the x86 CPU from Intel Corporation of Santa Clara, Calif. and the x64 CPU from Advanced Micro Devices of Sunnyvale, Calif.

An operating system kernel 230, portions of which are typically resident in memory 220 and executed by the CPU, functionally organizes the node by, inter alia, invoking operations in support of the software program code and application programs executing on the node. A suitable operating system kernel 230 may include the Windows® series of operating systems from Microsoft Corp of Redmond, Wash., the MAC OS® and IOS® series of operating systems from Apple Inc. of Cupertino, Calif., the Linux operating system and versions of the Android™ operating system from Google, Inc. of Mountain View, Calif., among others. Suitable application programs may include Adobe Reader® from Adobe Systems Inc. of San Jose, Calif. and Microsoft Word from Microsoft Corp of Redmond, Wash. Illustratively, the software program code may be implemented as user mode processes 240 of the kernel 230. As used herein, a process (e.g., a user mode process) is an instance of software program code (e.g., an application program) executing in the operating system that may be separated (decomposed) into one or more threads, wherein each thread is a sequence of execution within the process.

It will be apparent to those skilled in the art that other types of processing elements and memory, including various computer-readable media, may be used to store and execute program instructions pertaining to the embodiments described herein. Also, while the embodiments herein are described in terms of software program code, processes, and computer, e.g., application, programs stored in memory, alternative embodiments also include the code, processes and programs being embodied as engines and/or modules consisting of hardware, software, firmware, or combinations thereof.

Threat-Aware Microvisor

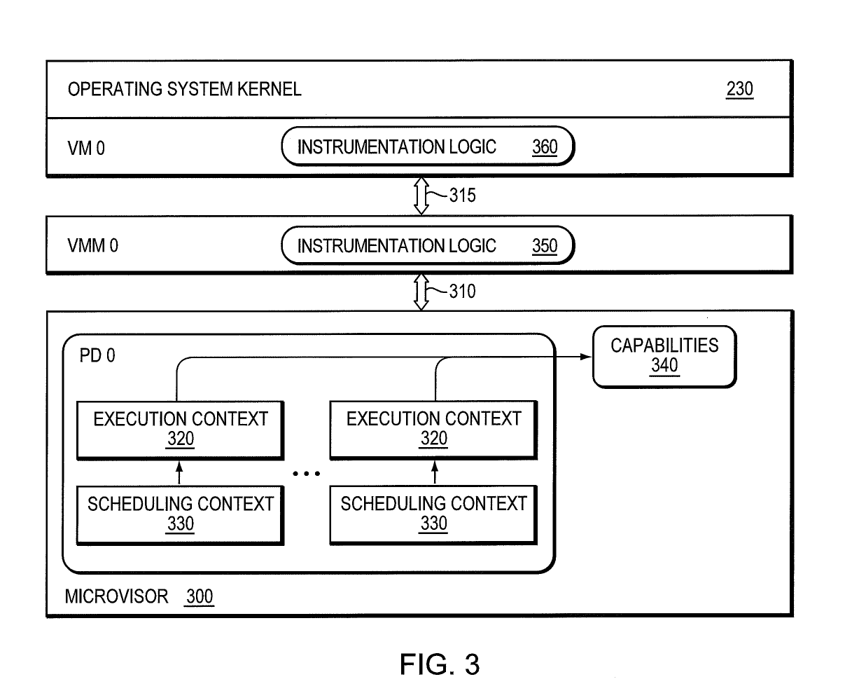

FIG. 3 is a block diagram of the threat-aware microvisor 300 that may be advantageously used with one or more embodiments described herein. The threat-aware microvisor (hereinafter “microvisor”) may be configured to facilitate run-time security analysis, including exploit and malware detection and threat intelligence, of operating system processes executing on the node 200. To that end, the microvisor may be embodied as a light-weight module disposed or layered beneath (underlying, i.e., directly on native hardware) the operating system kernel 230 of the node to thereby virtualize the hardware and control privileges (i.e., access control permissions) to kernel (e.g., hardware) resources of the node 200 that are typically controlled by the operating system kernel. Illustratively, the kernel resources may include (physical) CPU(s) 212, memory 220, network interface(s) 214, and devices 216. The microvisor 300 may be configured to control access to one or more of the resources in response to a request by an operating system process to access the resource.

As a light-weight module, the microvisor 300 may provide a virtualization layer having less functionality than a typical hypervisor. Therefore, as used herein, the microvisor 300 is a module (component) that underlies the operating system kernel 230 and includes the functionality of a micro-kernel (e.g., protection domains, execution contexts, capabilities and scheduling), as well as a subset of the functionality of a hypervisor (e.g., hyper-calls to implement a virtual machine monitor). Accordingly, the microvisor may cooperate with a unique virtual machine monitor (VMM), i.e., a type 0 VMM, to provide additional virtualization functionality in an operationally and resource efficient manner. Unlike a type 1 or type 2 VMM (hypervisor), the type 0 VMM (VMM 0) does not fully virtualize the kernel (hardware) resources of the node and supports execution of only one entire operating system/instance inside one virtual machine, i.e., VM 0. VMM 0 may thus instantiate VM 0 as a container for the operating system kernel 230 and its kernel resources. In an embodiment, VMM 0 may instantiate VM 0 as a module having instrumentation logic 360 directed to determination of an exploit or malware in any suspicious operating system process (kernel or user mode). Illustratively, VMM 0 is a pass-through module configured to expose the kernel resources of the node (as controlled by microvisor 300) to the operating system kernel 230. VMM 0 may also expose resources such as virtual CPUs (threads), wherein there is one-to-one mapping between the number of physical CPUs and the number of virtual CPUs that VMM 0 exposes to the operating system kernel 230. To that end, VMM 0 may enable communication between the operating system kernel (i.e., VM 0) and the microvisor over privileged interfaces 315 and 310.

The VMM 0 may include software program code (e.g., executable machine code) in the form of instrumentation logic 350 (including decision logic) configured to analyze one or more interception points originated by one or more operating system processes to invoke the services, e.g., accesses to the kernel resources, of the operating system kernel 230. As used herein, an interception point is a point in an instruction stream where control passes to (e.g., is intercepted by) either the microvisor, VMM 0 or another virtual machine. Illustratively, VMM 0 may contain computer executable instructions executed by the CPU 212 to perform operations that initialize and implement the instrumentation logic 350, as well as operations that spawn, configure, and control/implement VM 0 and any of a plurality of (micro) virtual machines including their instrumentation logic 360. Example threat-aware microvisor, VMM 0 and micro-virtual machine are described in U.S. patent application Ser. No. 14/229,580 titled Exploit Detection System with Threat-Aware Microvisor by Ismael et al., filed Mar. 28, 2014, which application is hereby incorporated by reference.

In an embodiment, the microvisor 300 may be organized to include a protection domain illustratively bound to VM 0. As used herein, a protection domain is a container for various data structures, such as execution contexts, scheduling contexts, and capabilities associated with the kernel resources accessible by an operating system process. Illustratively, the protection domain may function at a granularity of an operating system process (e.g., a user mode process 240) and, thus, is a representation of the process. Accordingly, the microvisor may provide a protection domain for the process and its run-time threads executing in the operating system. A main protection domain (PD0) of the microvisor controls all of the kernel resources available to the operating system kernel 230 (and, hence, the user mode process 240) of VM 0 via VMM 0 and, to that end, may be associated with the services provided to the user mode process by the kernel 230.

An execution context 320 is illustratively a representation of a thread (associated with an operating system process) and, to that end, defines a state of the thread for execution on CPU 212. In an embodiment, the execution context may include inter alia (i) contents of CPU registers, (ii) pointers/values on a stack, (iii) a program counter, and/or (iv) allocation of memory via, e.g., memory pages. The execution context 320 is thus a static view of the state of thread and, therefore, its associated process. Accordingly, the thread executes within the protection domain associated with the operating system process of which the thread is a part. For the thread to execute on a CPU 212 (e.g., as a virtual CPU), its execution context 320 is tightly linked to a scheduling context 330, which may be configured to provide information for scheduling the execution context 320 for execution on the CPU 212. Illustratively, the scheduling context information may include a priority and a quantum time for execution of its linked execution context on CPU 212.

In an embodiment, the capabilities 340 may be organized as a set of access control permissions to the kernel resources to which the thread may request access. Each time the execution context 320 of a thread requests access to a kernel resource, the capabilities 340 are examined. There is illustratively one set of capabilities 340 for each protection domain, such that access to kernel resources by each execution context 320 (i.e., each thread of an execution context) of a protection domain may be defined by the set of capabilities 340. For example, physical addresses of pages of memory 220 (resulting from mappings of virtual addresses to physical addresses) may have associated access permissions (e.g., read, write, read-write) within the protection domain. To enable an execution context 320 to access a kernel resource, such as a memory page, the physical address of the page may have a capability 340 that defines how the execution context 320 may reference that page. Illustratively, the capabilities may be examined by hardware (e.g., a hardware page fault upon a memory access violation) or by program code. A violation of a capability in a protection domain may be an interception point, which returns control to the VM (e.g., VM 0) bound to the protection domain.

Malware Detection Endpoint Architecture

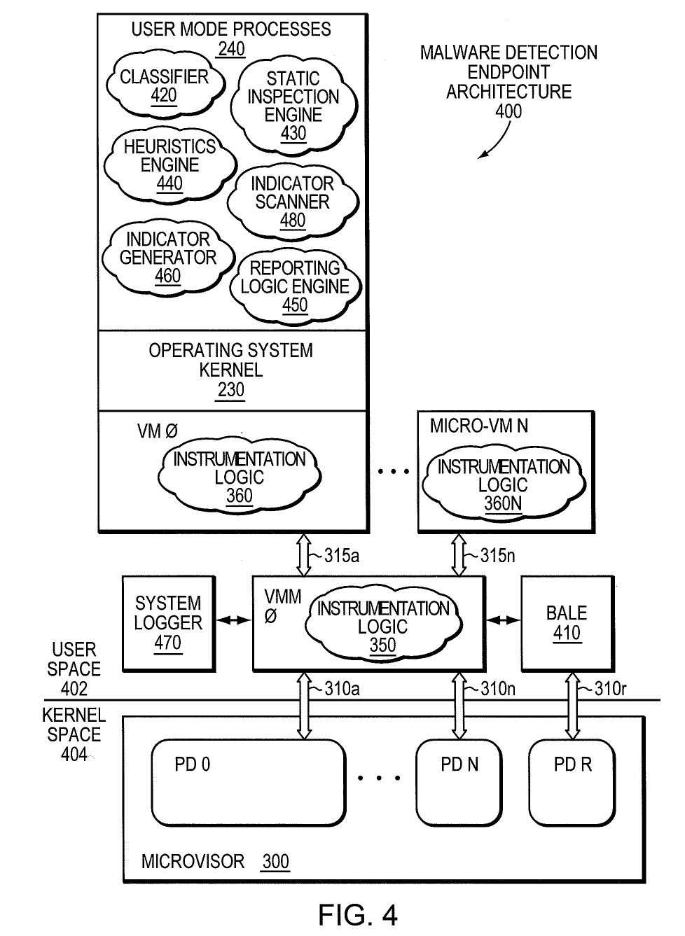

In an embodiment, the threat-aware microvisor 300 may be deployed in a micro-virtualization architecture as a module of a virtualization system executing on the endpoint 200_{E} to provide exploit and malware detection within the network environment 100. FIG. 4 is a block diagram of a malware detection endpoint architecture 400 that may be advantageously used with one or more embodiments described herein. Illustratively, the architecture 400 may organize the memory 220 of the endpoint 200_{E} as a user space 402 and a kernel space 404. In an embodiment, the microvisor may underlie the operating system kernel 230 and execute in the kernel space 404 of the architecture 400 to control access to the kernel resources of the endpoint 200_{E} for any operating system process (kernel or user mode). Notably, the microvisor 300 executes at the highest privilege level of the hardware (CPU) to thereby virtualize access to the kernel resources of the endpoint in a light-weight manner that does not share those resources among the user mode processes 240 when requesting the services of the operating system kernel 230. That is, there is one-to-one mapping between the resources and the operating system kernel, such that the resources are not shared.

A system call illustratively provides an interception point at which a change in privilege levels occurs in the operating system, i.e., from a privilege level of the user mode process to a privilege level of the operating system kernel. VMM 0 may intercept the system call and examine a state of the process issuing (sending) the call. The instrumentation logic 350 of VMM 0 may analyze the system call to determine whether the call is suspicious and, if so, instantiate (spawn) one or more “micro” virtual machines (VMs) equipped with monitoring functions that cooperate with the microvisor to detect anomalous behavior which may be used in determining an exploit or malware.

As used herein, an exploit may be construed as information (e.g., executable code, data, one or more commands provided by a user or attacker) that attempts to take advantage of a computer program or system vulnerability, often employing malware. Typically, a vulnerability may be a coding error or artifact of a computer program that allows an attacker to alter legitimate control flow during processing of the computer program by an electronic device and, thus, causes the electronic device to experience undesirable or unexpected behaviors. The undesired or unexpected behaviors may include a communication-based or execution-based anomaly which, for example, could (1) alter the functionality of the electronic device executing application software in a malicious manner; (2) alter the functionality of the electronic device executing the application software without any malicious intent; and/or (3) provide unwanted functionality which may be generally acceptable in another context. To illustrate, a computer program may be considered a state machine where all valid states (and transitions between states) are managed and defined by the program, in which case an exploit may be viewed as seeking to alter one or more of the states (or transitions) from those defined by the program. Malware may be construed as computer code that is executed by an exploit to harm or co-opt operation of an electronic device or misappropriate, modify or delete data. Conventionally, malware may often be designed with malicious intent, and may be used to facilitate an exploit. For convenience, the term “malware” may be used herein to describe a malicious attack, and encompass both malicious code and exploits detectable in accordance with the disclosure herein.

As used herein, the term “micro” VM denotes a virtual machine serving as a container that is restricted to a process (as opposed to VM 0 which is spawned as a container for the entire operating system.) Such spawning of a micro-VM may result in creation of an instance of another module (i.e., micro-VM N) that is substantially similar to VM 0, but with different (e.g., additional) instrumentation logic 360N illustratively directed to determination of an exploit or malware in the suspicious process by, e.g., monitoring its behavior. In an embodiment, the spawned micro-VM illustratively encapsulates an operating system process, such as user mode process 240. In terms of execution, operation of the process is controlled and synchronized by the operating system kernel 230; however, in terms of access to kernel resources, operation of the encapsulated process is controlled by VMM 0. Notably, the resources appear to be isolated within each spawned micro-VM such that each respective encapsulated process appears to have exclusive control of the resources. In other words, access to kernel resources is synchronized among the micro-VMs and VM 0 by VMM 0 rather than virtually shared. Similar to VM 0, each micro-VM may be configured to communicate with the microvisor (via VMM 0) over privileged interfaces (e.g., 315n and 310n).

In an embodiment, the privileged interfaces 310 and 315 may be embodied as a set of defined hyper-calls, which are illustratively inter process communication (IPC) messages exposed (available) to VMM 0, VM 0 (including any spawned micro-VMs) and any other isolated software program code (module). The hyper-calls are generally originated by VMM 0 and directed to the microvisor 300 over privileged interface 310, although VM0 and the micro-VMs may also originate one or more hyper-calls (IPC messages) directed to the microvisor over privileged interface 315. However, the hyper-calls originated by VM 0 and the micro-VMs may be more restricted than those originated by VMM 0.

In an embodiment, the microvisor 300 may be organized to include a plurality of protection domains (e.g., PD 0-R) illustratively bound to VM 0, one or more micro-VMs, and any isolated module, respectively. For example, the spawned micro-VM (e.g., micro-VM N) is illustratively associated with (bound to) a copy of PD 0 (e.g., PD N) which, in turn, may be bound to the process, wherein such binding may occur through memory context switching. In response to a decision to spawn the micro-VM N, VMM 0 may issue a hyper-call over interface 310 to the microvisor requesting creation of the protection domain PD N. Upon receiving the hyper-call, the microvisor 300 may copy (i.e., “clone”) the data structures (e.g., execution contexts, scheduling contexts and capabilities) of PD 0 to create PD N for the micro-VM N, wherein PD N has essentially the same structure as PD 0 except for the capabilities associated with the kernel resources. The capabilities for PD N may limit or restrict access to one or more of the kernel resources as instructed through one or more hyper-calls from, e.g., VMM 0 and/or micro-VM N over interface 310n to the microvisor. Such cloning of the PD 0 data structures may also be performed to create PD R for the isolated module disposed over the microvisor, as described further herein. Accordingly, the microvisor 300 may contain computer executable instructions executed by the CPU 212 to perform operations that initialize, clone and configure the protection domains.

Advantageously, the microvisor 300 may be organized as separate protection domain containers for the operating system kernel 230 (PD 0), one or more operating system processes (PD N) and any isolated module (PD R) to facilitate further monitoring and/or understanding of behaviors of a process and its threads. Such organization of the microvisor also enforces separation between the protection domains to control the activity of the monitored process. Moreover, the microvisor 300 may enforce access to the kernel resources through the use of variously configured capabilities of the separate protection domains. Unlike previous virtualization systems, separation of the protection domains to control access to kernel resources at a process granularity enables detection of anomalous behavior of an exploit or malware. That is, in addition to enforcing access to kernel resources, the microvisor enables analysis of the operation of a process within a spawned micro-VM to detect exploits or other malicious code threats that may constitute malware.

The user mode processes 240 and operating system kernel 230 may execute in the user space 402 of the endpoint architecture 400, although it will be understood to those skilled in the art that the user mode processes may execute in another address space defined by the operating system kernel. Illustratively, the operating system kernel 230 may execute under control of the microvisor at a privilege level (i.e., a logical privilege level) lower than a highest privilege level of the microvisor, but at a higher CPU privilege level than that of the user mode processes 240. In addition, VMM 0 and its spawned VMs (e.g., VM 0 and micro-VM 1) may execute in user space 402 of the architecture 400. As a type 0 virtual machine monitor, VMM 0 (and its spawned VM 0 and micro-VMs) may execute at the highest (logical) privilege level of the microvisor. That is, VMM 0 (and its spawned VM 0 and micro-VMs) may operate under control of the microvisor at the highest microvisor privilege level, but may not directly operate at the highest CPU (hardware) privilege level.

Illustratively, the instrumentation logic 350 of VMM 0 may include monitoring logic configured to monitor and collect capability violations (e.g., generated by CPU 212) in response to one or more interception points to thereby infer an exploit or malware. Inference of an exploit or malware may also be realized through sequences of interception points wherein, for example, a system call followed by another system call having certain parameters may lead to an inference that the process sending the calls is an exploit or malware. The interception point thus provides an opportunity for VMM 0 to perform “light-weight” (i.e., limited so as to maintain user experience at the endpoint with little performance degradation) analysis to evaluate a state of the process in order to detect a possible exploit or malware without requiring any policy enforcement. VMM 0 may then decide to spawn a micro-VM and configure the capabilities of its protection domain to enable deeper monitoring and analysis (e.g., through interception points and capability violations) in order to determine whether the process is an exploit or malware. Notably, the analysis may also classify the process as a type of exploit (e.g., a stack overflow) or as malware and may even identify the same. As a result, the invocation of instrumentation and monitoring logic of VMM 0 and its spawned VMs in response to interception points originated by operating system processes and capability violations generated by the microvisor advantageously enhance the virtualization system described herein to provide an exploit and malware detection system configured for run-time security analysis of the operating system processes executing on the endpoint.

VMM 0 may also log the state of the monitored process within system logger 470. In an embodiment, the state of the process may be realized through the contents of the execution context 320 (e.g., CPU registers, stack, program counter, and/or allocation of memory) executing at the time of each capability violation. In addition, the state of the process may be realized through correlation of various activities or behavior of the monitored process. The logged state of the process may thereafter be exported from the system logger 470 to the MDS 200_{M} of the network environment 100 by, e.g., forwarding the state as one or more IPC messages through VMM 0 (VM 0) and onto a network protocol stack (not shown) of the operating system kernel. The network protocol stack may then format the messages as one or more packets according to, e.g., a syslog protocol such as RFC 5434 available from IETF, for transmission over the network to the MDS 200_{M}.

Malware Detection

Exploit and malware detection on the endpoint may be performed in accordance with one or more processes embodied as software modules or engines containing computer executable instructions executed by the CPU to detect suspicious and/or malicious behaviors of an operating system process (including an application program) when, e.g., executing an object, and to correlate and classify the detected behaviors as indicative of malware (i.e., a matter of probability). Notably, the endpoint may perform (implement) exploit and malware detection as background processing (i.e., minor use of endpoint resources) with data processing being implemented as its primary processing (e.g., in the foreground having majority use of endpoint resources), whereas the MDS appliance implements such detection as its primary processing (i.e., majority use of appliance resources). Detection of a suspicious and/or malicious object may be performed at the endpoint by static and dynamic analysis of the object. As used herein, an object may include, for example, a web page, email, email attachment, file or universal resource locator. Static analysis may perform light-weight (quick) examination of the object to determine whether it is suspicious, while dynamic analysis may instrument the behavior of the object as the operating system process executes (runs) via capability violations of, e.g. operating system events. A behavioral analysis logic engine (BALE) 410 and a classifier 420 may thereafter cooperate to perform correlation and classification of the detected behaviors as malicious or not. That is, the BALE 410 and classifier 420 may cooperate to analyze and classify observed behaviors of the object (based on the events) as indicative of malware.

In an embodiment, the static analysis may perform light-weight examination of the object (including a network packet) to determine whether it is suspicious and/or malicious. To that end, the static analysis may include a static inspection engine 430 and a heuristics engine 440 executing as user mode processes of the operating system kernel 230. The static inspection engine 430 and heuristics engine 440 may employ statistical analysis techniques, including the use of vulnerability/exploit signatures and heuristics, to perform non-behavioral analysis in order to detect anomalous characteristics (i.e., suspiciousness and/or malware) without execution (i.e., monitoring run-time behavior) of the object. For example, the static inspection engine 430 may employ signatures (referred to as vulnerability or exploit “indicators”) to match content (e.g., bit patterns) of the object with patterns of the indicators in order to gather information that may be indicative of suspiciousness and/or malware. The heuristics engine 440 may apply rules and/or policies to detect anomalous characteristics of the object in order to identify whether the object is suspect and deserving of further analysis or whether it is non-suspect (i.e., benign) and not in need of further analysis. The statistical analysis techniques may produce static analysis results that include, e.g., identification of communication protocol anomalies and/or suspect source addresses of known malicious servers.

In an embodiment, the static inspection engine 430 may be configured to compare the object's bit pattern content with a “blacklist” of suspicious exploit indicator patterns. For example, a simple indicator check (e.g., hash) against the hashes of the blacklist (i.e., exploit indicators of objects deemed suspicious) may reveal a match and a score may be generated (based on the content) that may be generally indicative of suspiciousness of the object. Illustratively, the exploit indicators (which may not necessarily represent malware) may be indicative of specific types of objects (which define particular operating system processes or applications) that are prohibited from running on the endpoint. In this embodiment, the instrumentation logic 350 of VMM 0 may implement a policy that blocks execution of the object in response to an indicator match. In addition to such a blacklist of suspicious objects, bit patterns of the object may be compared with a “whitelist” of permitted indicator patterns.

The dynamic analysis may include exploit detection performed by, e.g., the microvisor 300 and micro-VM N to observe behaviors of the object. In an embodiment, exploit detection at the endpoint does not generally wait for results from the static analysis. The behaviors of the object may be observed by instrumenting the object (using, e.g., instrumentation logic 360N) as the operating system process runs at micro-VM N, wherein the observed run-time behaviors may be captured by the microvisor 300 and VMM 0, and provided to the BALE 410 as dynamic analysis results. Illustratively, monitors may be employed during the dynamic analysis to monitor the run-time behaviors of the object and capture any resulting activity. The monitors may be embodied as capability violations configured to trace particular operating system events. During instrumenting of the object at the micro-VM, the system events may trigger capability violations (e.g., exceptions or traps) generated by the microvisor 300 to enable monitoring of the object's behaviors during run-time.

In an embodiment, the monitors may include breakpoints within code of the object (process) being monitored. The breakpoints may be configured to trigger capability violations used to gather or monitor the run-time behaviors. For instance, a breakpoint may be inserted into a section of code of the process (e.g., operating system process) running in the operating system kernel 230. When the code executes, e.g., in response to the process accessing the object, an interception point may be triggered and a capability violation generated to enable monitoring of the executed code. In other words, an exception may be generated on the breakpoint and execution of the code by the process may be tracked by the microvisor 300 and VMM 0, where the exception is a capability violation. Thereafter, instrumentation logic 350 of VMM 0 may examine, e.g., a stack to determine if there is suspect behavior or activity to therefore provide a deeper level of dynamic analysis results.

The static analysis results and dynamic analysis results may be stored in memory 220 (e.g., in system logger 470) and provided (e.g., as inputs via VMM 0) to the BALE 410, which may provide correlation information (e.g., as an output via VMM 0) to the classifier 420. Alternatively, the results or events may be provided or reported to the MDS 200_{M} for correlation. The BALE 410 may be embodied as a rules-based correlation engine illustratively executing as an isolated process (module) disposed over the microvisor 300 within the architecture 400. In accordance with the malware detection endpoint architecture 400, the BALE 410 is illustratively associated with (bound to) a copy of PD 0 (e.g., PD R). The microvisor 300 may copy (i.e., “clone”) the data structures (e.g., execution contexts, scheduling contexts and capabilities) of PD 0 to create PD R for the BALE 410, wherein PD R has essentially the same structure as PD 0 except for the capabilities associated with the kernel resources. The capabilities for PD R may limit or restrict access to one or more of the kernel resources as requested through one or more hyper-calls from, e.g., BALE 410 over interface 310r to the microvisor.

In an embodiment, the BALE 410 may be configured to operate on correlation rules that define, among other things, sequences of known malicious events (if-then statements with respect to, e.g., attempts by a process to change memory in a certain way that is known to be malicious). The events may collectively correlate to malicious behavior. As noted, a micro-VM may be spawned to instrument a suspect process (object) and cooperate with the microvisor 300 and VMM 0 to generate capability violations in response to interception points, which capability violations are provided as dynamic analysis result inputs to the BALE 410. The rules of the BALE 410 may then be correlated against those dynamic analysis results, as well as static analysis results, to generate correlation information pertaining to, e.g., a level of risk or a numerical score used to arrive at a decision of (deduce) maliciousness. The classifier 420 may be embodied as a classification engine executing as a user mode process of the operating system kernel 230 and configured to use the correlation information provided by BALE 410 to render a decision as to whether the object is malicious. Illustratively, the classifier 420 may be configured to classify the correlation information, including monitored behaviors (expected and unexpected/anomalous) and capability violations, of the object relative to those of known malware and benign content.

Periodically, rules may be pushed from the MDS 200_{M} to the endpoint 200_{E} to update the BALE 410, wherein the rules may be embodied as different (updated) behaviors to monitor. For example, the correlation rules pushed to the BALE may include, e.g., whether a running process or application program has spawned processes, requests to use certain network ports that are not ordinarily used by the application program, and/or attempts to access data in memory locations not allocated to the application program. The MDS 200_{M} may also push types of system events and capabilities for monitoring and triggering by the microvisor 300 and VMM 0. The correlation rules, system events and capabilities ensure that the endpoint 200_{E} operates with current and updated malware behavior detection instrumentality needed to observe behaviors of suspect processes/objects for subsequent correlation by the BALE correlation engine.

Illustratively, the BALE 410 and classifier 420 may be implemented as separate modules as described herein although, in an alternative embodiment, the BALE 410 and classifier 420 may be implemented as a single module disposed over (i.e., running on top of) the microvisor 300. The BALE 410 may be configured to correlate observed behaviors (e.g., results of static and dynamic analysis) with known malware and/or benign objects (embodied as defined rules) and generate an output (e.g., a level of risk or a numerical score associated with an object) that is provided to and used by the classifier 420 to render a decision of malware based on the risk level or score exceeding a probability threshold. A reporting logic engine 450 may execute as a user mode process in the operating system kernel 230 that is configured to generate an alert for transmission external to the endpoint (to, e.g., one or more other endpoints 200_{E}, a management appliance, or MDS 200_{M}) in accordance with “post-solution” activity.

In an embodiment, the endpoint 200_{E} may include one or more modules executing as user mode process(es) in the operating system kernel 230 and configured to create indicators (signatures) of observed behaviors of a process/object as indicative of malware and organize those indicators as reports for distribution to other endpoints. To that end, the endpoint may include an indicator generator 460 configured to generate the malware indicators for distribution to other endpoints 200_{E}. Illustratively, the malware indicators may not be typical code indicators, e.g., anti-virus (AV) signatures; rather, the malware indicators may be embodied as one or more hashes of the object classified as malware, possibly including identification information regarding its characteristics and/or behaviors observed during static and dynamic analysis. The indicator generator 460 may be further configured to generate both malware indicators and typical AV signatures to thereby provide a more robust set of indicators/signatures. These indicators may be used internally by the endpoint or distributed externally as original indicator reports to other endpoints.

The original indicator reports may also be provided to an intermediate node 200_{I}, such as a management appliance, within the private (customer) network 130, which may be configured to perform a management function to, e.g., distribute the reports to other appliances within the customer network, as well as to nodes within a malware detection services and equipment supplier network (e.g., supplier cloud infrastructure) for verification of the indicators and subsequent distribution to other MDS appliances and/or among other customer networks. Illustratively, the reports distributed by the management appliance may include the entire or portions of the original indicator reports provided by the MDS appliance, or may include new reports that are derived from the original reports. Unlike previous systems where such reporting activity originated from the management appliance of the customer network, such reporting activity may originate from the endpoint 200_{E}. An indicator scanner 480 may be configured to obviate (prevent) processing of a suspect process/object based on the robust set of indicators in the report. For example, the indicator scanner 480 may perform indicator comparison and/or matching while the suspect process/object is instrumented by the micro-VM. In response to a match, the indicator scanner 480 may cooperate with the microvisor 300 to terminate execution of the process/object.

In an embodiment, the endpoint 200_{E} may be equipped with capabilities to defeat countermeasures employed by known malware, e.g., where malware may detect that it (i.e., process/object) is running on the microvisor 300 (e.g., through exposure of environmental signatures that can be used to identify the microvisor). In accordance with the malware detection endpoint architecture 400, such behavior may be used to qualify suspiciousness. For example if a suspect object attempts to “sleep,” the microvisor 300 and VMM 0 may detect such sleeping activity, but may be unable to accelerate sleeping because of run-time implications at the endpoint 200_{E}. However, the microvisor 300 and VMM 0 may record the activity as an event that is provided to the correlation engine (BALE 410). The object may implement measures to identify that it is running in a microvisor environment; accordingly, the endpoint 200_{E} may implement countermeasures to provide strong isolation of the object during execution. The object may then execute and manifest behaviors that are captured by the microvisor and VMM 0. In other words, the microvisor and VMM 0 may detect (as a suspicious fact) that the suspect object has detected the microvisor. The object may then be allowed to run (while hiding the suspicious fact) and its behaviors observed. The suspicious fact that is detected may also be provided to the correlation engine (BALE 410) and classification engine (classifier 420) for possible classification as malware.

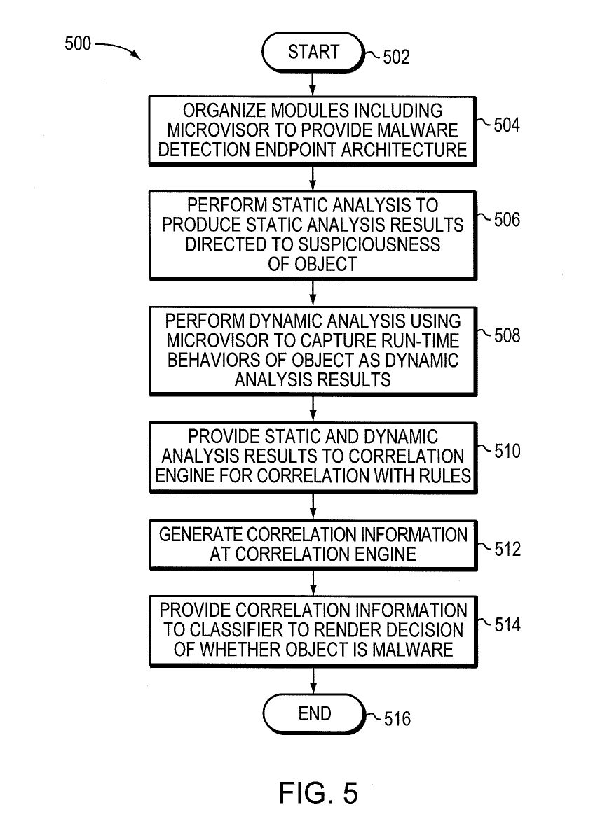

FIG. 5 is an example procedure for deploying the threat-aware microvisor in a malware detection endpoint architecture to provide exploit and malware detection on an object of an operating system process executing on the endpoint. The procedure 500 starts at step 502 and proceeds to step 504 where a plurality of software modules or engines, including the microvisor, as well as VMM 0 and a micro-VM, executing on the endpoint are organized to provide the malware detection endpoint architecture. At step 506, static analysis of the object may be performed by, e.g., a static inspection engine and a heuristics engine to produce static analysis results directed to whether the object is suspicious. At step 508, dynamic analysis of the object may be performed by, e.g., the microvisor, VMM 0 and micro-VM to capture run-time behaviors of the object as dynamic analysis results. At step 510, the static analysis results and dynamic analysis results may be provided to a correlation engine (BALE) for correlation with correlation rules and, at step 512, the correlation engine may generate correlation information. At step 514, the correlation information may be provided to a classifier to render a decision of whether the object is malware. The procedure then ends at step 516.

Trusted Computing Base (TCB)

In an embodiment, the microvisor 300 may be stored in memory as a module of a trusted computing base (TCB) that also includes a root task module (hereinafter “root task”) configured to cooperate with the microvisor to create (i.e., load) one or more other modules executing on the CPU 212 of the endpoint 200_{E}. In addition, one or more of the malware detection system engines (modules) described herein may be included in the TCB to provide a trusted malware detection environment. For example, the BALE 410 may be loaded and included as a module in the TCB for the endpoint 200_{E}.

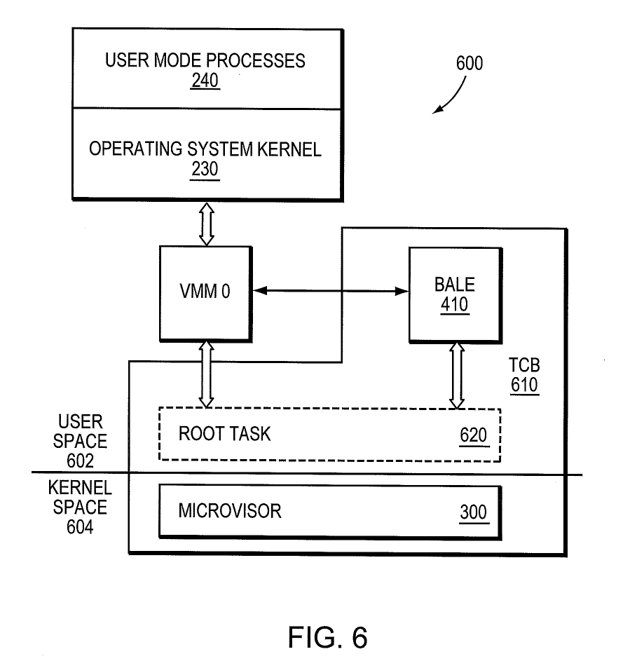

FIG. 6 is a block diagram of an exemplary micro-virtualization architecture 600 including a TCB 610 that may be configured to provide a trusted malware detection environment in accordance with one or more embodiments described herein. The microvisor 300 may be disposed as a relatively small code base (e.g., approximately 9000-10,000 lines of code) that underlies the operating system kernel 230 and executes in kernel space 604 of the architecture 600 to control access to the kernel resources for any operating system process (kernel or user mode). As noted, the microvisor 300 executes at the highest privilege level of the hardware (CPU) to virtualize access to the kernel resources of the node in a light-weight manner. The root task 620 may be disposed as a relatively small code base (e.g., approximately 1000 lines of code) that overlays the microvisor 300 (i.e., underlies VMM 0) and executes in user space 602 of the architecture 600. Through cooperation (e.g., communication) with the microvisor, the root task 620 may also initialize (i.e., initially configure) the loaded modules executing in the user space 602. For example, the root task 620 may initially configure and load the BALE 410 as a module of the TCB 610.

In an embodiment, the root task 620 may execute at the highest (absolute) privilege level of the microvisor. Illustratively, the root task 620 may communicate with the microvisor 300 to allocate the kernel resources to the loaded user space modules. In this context, allocation of the kernel resources may include creation of, e.g., maximal capabilities that specify an extent to which each module (such as, e.g., VMM 0 and/or BALE 410) may access its allocated resource(s). For example, the root task 620 may communicate with the microvisor 300 through instructions to allocate memory and/or CPU resource(s) to VMM 0 and BALE 410, and to create capabilities that specify maximal permissions allocated to VMM 0 and BALE 410 when attempting to access (use) the resource(s). Such instructions may be provided over a privileged interface embodied as one or more hyper-calls. Notably, the root task 620 is the only (software or hardware) entity that can instruct the microvisor with respect to initial configuration of such resources.

In an embodiment, the root task 620 may be implemented as a “non-long lived” process that terminates after creation and initial configuration of the user space processes (modules). The non-long lived nature of the root task is depicted by dash lining of the root task 620 in FIG. 6. Illustratively, the root task 620 is the first user space process to boot (appear) during power-up and initialization of the node, including loading and initial configuration of the user space modules and their associated capabilities; the root task then terminates (disappears). The root task 620 may thereafter be re-instantiated (reappear) during a reboot process, which may be invoked in response to an administrative task, e.g., update of VMM 0. Notably, the root task 620 may only appear and operate on the node in response to a (re)boot process, thereby enhancing security of the TCB 610 by restricting the ability to (re)initialize the microvisor 300 after deployment on the endpoint 200_{E}.

As a trusted module of the TCB, the microvisor 300 is illustratively configured to enforce a security policy of the TCB that, e.g., prevents (obviates) alteration or corruption of a state related to security of the microvisor by a module (e.g., software entity) of or external to an environment in which the microvisor 300 operates, i.e., the TCB 610. For example, an exemplary security policy may provide, “modules of the TCB shall be immutable,” which may be implemented as a security property of the microvisor, an example of which is no module of the TCB modifies a state related to security of the microvisor without authorization. In an embodiment, the security policy of the TCB 610 may be implemented by a plurality of security properties of the microvisor 300. That is, the exemplary security policy may be also implemented (i.e., enforced) by another security property of the microvisor, another example of which is no module external to the TCB modifies a state related to security of the microvisor without authorization. As such, one or more security properties of the microvisor may operate concurrently to enforce the security policy of the TCB. An example trusted threat-aware microvisor is described in U.S. Provisional Patent Application No. 62/019,701 titled Trusted Threat-Aware Microvisor by Ismael et al., having a priority date of Jul. 1, 2014.

Illustratively, the microvisor 300 may manifest (i.e., demonstrate) the security property in a manner that enforces the security policy. Accordingly, verification of the microvisor to demonstrate the security property necessarily enforces the security policy, i.e., the microvisor 300 may be trusted by demonstrating the security property. Trusted (or trustedness) may therefore denote a predetermined level of confidence that the microvisor demonstrates the security property (i.e., the security property is a property of the microvisor). It should be noted that trustedness may be extended to other security properties of the microvisor, as appropriate. Furthermore, trustedness may denote a predetermined level of confidence that is appropriate for a particular use or deployment of the microvisor 300 (and TCB 610). The predetermined level of confidence, in turn, is based on an assurance (i.e., grounds) that the microvisor demonstrates the security property. Therefore, manifestation denotes a demonstrated implementation that assurance is provided regarding the implementation based on an evaluation assurance level, i.e., the more extensive the evaluation, the greater the assurance level. Evaluation assurance levels for security are well-known and described in Common Criteria for Information Technology Security Evaluation Part 3: Security Assurance Components, September 2012, Ver. 3.1 (CCMB-2012-09-003).

While there have been shown and described illustrative embodiments for deploying the threat-aware microvisor in a malware detection endpoint architecture executing on an endpoint to provide exploit and malware detection within a network environment, it is to be understood that various other adaptations and modifications may be made within the spirit and scope of the embodiments herein. For example, embodiments have been shown and described herein with relation to providing a trusted malware detection environment having a TCB 610 that includes the BALE 410 as well as the microvisor 300 and root task 620. However, the embodiments in their broader sense are not so limited, and may, in fact, allow organization of other modules associated with a decision of malware to be part of the TCB. For example, the BALE 410 and classifier 420 may be loaded and included as modules in the TCB 610 for the endpoint 200_{E} to provide the trusted malware detection environment.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks, electronic memory, and/or CDs) having program instructions executing on a computer, hardware, firmware, or a combination thereof. Moreover, the embodiments or aspects thereof can be implemented in hardware, firmware, software, or a combination thereof. In the foregoing description, for example, in certain situations, terms such as “engine,” “component” and “logic” are representative of hardware, firmware and/or software that is configured to perform one or more functions. As hardware, engine (or component/logic) may include circuitry having data processing or storage functionality. Examples of such circuitry may include, but is not limited or restricted to a microprocessor, one or more processor cores, a programmable gate array, a microcontroller, an application specific integrated circuit, semiconductor memory, or combinatorial logic. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A system comprising:
a memory of an endpoint coupled to a network, the memory configured to store an operating system process, a plurality of user mode processes, and a microvisor deployed in a malware detection endpoint architecture of the endpoint; and
a central processing unit (CPU) coupled to the memory and adapted to execute the operating system process, the user mode processes, and the microvisor, wherein the user mode processes and the microvisor when executed are operable to:
perform static analysis of an object of the operating system process to detect anomalous characteristics of the object as static analysis results;
perform dynamic analysis of the object to observe behaviors of the object via one or more capability violations as the operating system process executes, wherein the behaviors are captured as dynamic analysis results;
correlate the static analysis results and dynamic analysis results against correlation rules to generate correlation information pertaining to a level of risk used to arrive at a decision of maliciousness; and
render a decision of whether the object is malicious by classifying the correlation information of the object relative to known malware and benign content.

2. The system of claim 1 wherein the microvisor is organized as a main protection domain representative of the operating system process and including one or more execution contexts and capabilities defining permissions for the operating system process to access kernel resources of the endpoint.

3. The system of claim 2 further comprising a virtual machine monitor (VMM) stored in the memory and executable by the CPU, the VMM when executed operable to:
spawn a micro-virtual machine as a container configured to encapsulate the operating system process;
clone the main protection domain by copying the execution contexts and capabilities to create a cloned protection domain representative of the operating system process, wherein the capabilities of the cloned protection domain are more restricted than the capabilities of the main protection domain with respect to access to the kernel resources; and
cooperate with the micro-virtual machine to monitor operation of the operating system process encapsulated in the micro-virtual machine as the operating system process attempts to access one or more of the kernel resources.

4. The system of claim 3 wherein the microvisor when executed is further operable to generate the one or more capability violations at the cloned protection domain in response to the operating system process attempting to access one or more of the kernel resources.

5. The system of claim 4 wherein the dynamic analysis comprises exploit detection to observe the behaviors of the object by instrumenting the object as the operating system process executes at the micro-virtual machine.

6. The system of claim 5 wherein the dynamic analysis further comprises monitors configured to monitor run-time behaviors of the object, the monitors embodied as the one or more capability violations configured to trace one or more operating system events.

7. The system of claim 6 wherein the monitors comprise breakpoints inserted within code of the operating system process, wherein the breakpoints are configured to trigger the one or more capability violations in response to the operating system process accessing the object to monitor the run-time behaviors.

8. The system of claim 4 wherein the user mode processes comprise an indicator generator stored in the memory and executable by the CPU, the indicator generator when executed operable to create behavioral indicators of observed behaviors of the object as indicative of malware.

9. The system of claim 8 wherein the behavioral indicators are embodied as signatures of behaviors of malware observed during the dynamic analysis of the object.

10. The system of claim 9 wherein the indicator generator is configured to generate the behavioral indicators and anti-virus signatures to provide a robust set of indicators for use by the endpoint.

11. The system of claim 10 wherein the indicator generator is further configured to organize the behavioral indicators as indicator reports for distribution to an intermediate node of the network and for distribution to appliances within other networks.

12. The system of claim 11 wherein the user mode processes comprise an indicator scanner stored in the memory and executable by the CPU, the indicator scanner when executed operable to prevent processing of the object based on the robust set of indicators in the report.

13. The system of claim 12 wherein the indicator scanner is configured to:
perform indicator comparison and matching as the object is instrumented by the micro-virtual machine; and
in response to a match, cooperate with the microvisor to terminate execution of the operating system process.

14. The system of claim 1 wherein the user mode processes comprise a static inspection engine stored in the memory and executable by the CPU, the static inspection engine when executed operable to match bit patterns of indicators with bit patterns of the object, wherein the indicators are exploit indicators used to gather information indicative of suspiciousness.

15. The system of claim 14 wherein the indicators are vulnerability indicators and wherein the static inspection engine is further configured to compare the bit patterns of the object with bit patterns of the vulnerability indicators, wherein the vulnerability indicators are indicative of types of objects prohibited from running on the endpoint.

16. The system of claim 1 wherein the user mode processes comprise a heuristics engine stored in the memory and executable by the CPU, the heuristics engine when executed operable to apply policies to detect anomalous characteristics of the object in order to identify whether the object is suspect and deserving of further analysis or whether it is non-suspect and not in need of further analysis.

17. The system of claim 1 wherein the user mode processes comprise a behavioral analysis logic engine (BALE) stored in the memory and executable by the CPU, the BALE when executed operable to correlate the static analysis results and the dynamic analysis results by operating on correlation rules that define sequences of known malicious events, the BALE embodied as a rules-based correlation engine executing as an isolated process disposed over the microvisor within the malware detection endpoint architecture of the endpoint.

18. The system of claim 17 wherein the user mode processes comprise a classifier stored in the memory and executable by the CPU, the classifier when executed operable to render the decision of whether the object is malicious based on the risk level exceeding a probability threshold.

19. A method comprising:
performing static analysis of an object of an operating system process stored in a memory of an endpoint, the static analysis performed to detect anomalous characteristics of the object as static analysis results;
performing dynamic analysis of the object at the endpoint to observe behaviors of the object via one or more capability violations as the operating system process executes, wherein the behaviors are captured as dynamic analysis results;
correlating the static analysis results and dynamic analysis results against correlation rules to generate correlation information pertaining to a level of risk used arrive at a decision of maliciousness; and
rendering a decision of whether the object is malicious by classifying the correlation information of the object relative to known malware and benign content.

20. The method of claim 19 further comprising:
spawning a micro-virtual machine as a container configured to encapsulate the operating system process;
cloning a main protection domain of a microvisor stored in the memory by copying execution contexts and capabilities of the main protection domain to create a cloned protection domain representative of the operating system process, wherein the capabilities of the cloned protection domain are more restricted than the capabilities of the main protection domain with respect to access to kernel resources of the endpoint; and
monitoring operation of the operating system process encapsulated in the micro-virtual machine as the operating system process attempts to access one or more of the kernel resources.

21. The method of claim 20 wherein
generating the one or more capability violations at the cloned protection domain in response to the operating system process attempting to access one or more of the kernel resources.

22. The method of claim 21 wherein
observing the behaviors of the object by instrumenting the object as the operating system process executes at the micro-virtual machine.

23. A method comprising:
deploying a microvisor in a malware detection endpoint architecture of an endpoint, the microvisor having a main protection domain representative of a process executing in an operating system of the architecture, the main protection domain including one or more execution contexts and capabilities defining permissions for the process to access kernel resources of the endpoint;
spawning a micro-virtual machine as a container configured to encapsulate the process, the micro-virtual machine bound to a clone of the main protection domain representative of the operating system process;
performing dynamic analysis of the process to observe behaviors of the process via one or more capability violations as the process executes in the micro-virtual machine, the one or more capability violations generated by the microvisor at the cloned of the main protection domain, wherein the behaviors are captured as dynamic analysis results;
correlating the dynamic analysis results against correlation rules to generate correlation information pertaining to a level of risk used to arrive at a decision of maliciousness; and
rendering a decision of whether the process is malicious by classifying the correlation information of the process relative to known malware and benign content.

24. A non-transitory computer readable medium including program instructions for execution on one or more processors, the program instructions when executed operable to:
perform static analysis of an object of an operating system process stored in a memory of an endpoint, the static analysis performed to detect anomalous characteristics of the object as static analysis results;
perform dynamic analysis of the object at the endpoint to observe behaviors of the object via one or more capability violations as the operating system process executes, wherein the behaviors are captured as dynamic analysis results;
correlate the static analysis results and dynamic analysis results against correlation rules to generate correlation information pertaining to a level of risk used to arrive at a decision of maliciousness; and
render a decision of whether the object is malicious by classifying the correlation information of the object relative to known malware and benign content.

25. A system comprising:
a microvisor disposed beneath an operating system kernel of an endpoint and executing in kernel space of an architecture to control access to kernel resources of the endpoint for an operating system process;
a root task disposed over the microvisor and executing in user space of the architecture, the root task configured to communicate with the microvisor to allocate the kernel resources to user space modules loaded onto the endpoint; and
a behavioral analysis logic engine (BALE) disposed over the microvisor and executing in the user space of the architecture, the BALE embodied as a rules-based correlation engine to correlate results of static and dynamic analysis of an object executing on the endpoint against correlation rules to generate correlation information used to arrive at a decision of maliciousness;
wherein the microvisor, root task and BALE are organized as a trusted computing base (TCB), wherein the microvisor is configured to enforce a security property that is prevents alteration of a state related to the security property of the microvisor, wherein the microvisor is further configured to implement the security property such that no module of the TCB modifies the state related to security of the microvisor without authorization, and wherein trustedness of the microvisor provides a predetermined level of confidence that the security property is implemented by the microvisor.
